(19) United States
(12) Patent Application Publication
(10) Pub. No.: US 2004/0203623 A1
(43) Pub. Date: Oct. 14, 2004

(54) Scheme to retransmit radio resource control messages during a radio link control reset in a wireless communication system

(76) Inventor: Frank Chih-Hsiang Wu, Shindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/337,339

(22) Filed: Jan. 7, 2003

Related U.S. Application Data
(60) Provisional application No. 60/377,227, filed on May 3, 2002.

(51) Int. Cl. H04B 17/00; H04M 11/10; H04M 3/42

(52) U.S. Cl. 455/412.1; 455/67.11; 455/414.1

(57) ABSTRACT

The present invention provides a scheme for handling radio resource control messages during a radio link control reset in a wireless communication system. Conventionally, if an RLC reset occurs before receiving positive acknowledgements of all RLC PDUs transmitted, the PDUs not correctly received cannot be retransmitted after an RLC reset. The upper layer usually sets a timer for retransmission of an upper layer message contained in this RRC message. The RLC reset delays the transmission of messages of the upper layer. However, with the present invention, because the RRC is informed of the RLC reset, the RRC can retransmit those messages which were submitted to the RLC before the RLC reset and might not be received correctly by the peer RRC due to the RLC reset. In this way, data loss and delays associated with the conventional method are avoided and system performance in wireless communications is improved.

### BACKGROUND OF THE INVENTION

1. Field of the Invention

The present invention relates to a wireless communications protocol. More specifically, the present invention discloses a scheme for handling radio resource control (RRC) messages during and after a radio link control (RLC) reset in a wireless communication system.

2. Description of the Prior Art

Advancements in communication technologies have allowed new types of communication systems to be made possible. Such new types of communication systems have for the most part, permitted increased rates of data transmission as well as related amounts of data to be communicated in such new communication systems.

These advancements in communication technologies have allowed new types of radio communication systems to be introduced and popularization. Among these advancements has been the use of radio communication systems to form at least a part of the communication path so the use of conventional wirelines is reduced.

However, radio or wireless communication systems can be constrained by certain limitations. These limitations, such as bandwidth and error correction limitations, affect the overall wireless communication system performance. If a system is unable to handle or recover from different types of errors, the system performance is degraded. Depending upon the severity of such errors, the wireless communication system can be hampered or even rendered inoperable.

In various situations and conditions, unspecified or improper actions during or after a reset procedure may result in serious problems for the wireless communication system. These problems include wasted system resources, data loss, unnecessary retransmissions, and unsuccessful data decompression.

Therefore, there is need for an improved scheme for efficiently handling RRC messages during and after an RLC reset so that inappropriate actions are avoided, errors are reduced, system resources are not wasted, and wireless communication system performance is improved.

### SUMMARY OF THE INVENTION

To achieve advantages and in order to overcome the disadvantages of the conventional method in accordance with the purpose of the invention as embodied and broadly described herein, the present invention discloses a method for specifying actions for handling RRC messages during and after an RLC RESET which thereby improves wireless communication system performance and reduces wasting of system resources.

An RLC reset procedure is used to reset two RLC peer entities, which are operating in acknowledged mode. During the reset procedure the hyper frame numbers (HFN) in universal mobile telecommunications system terrestrial radio access network (UTRAN) and user equipment (UE) are synchronised. Two HFNs used for ciphering need to be synchronised, downlink HFN (DL HFN) in downlink and uplink HFN (UL HFN) in uplink. In the reset procedure, the highest UL HFN and DL HFN used by the RLC entity in the transmitting sides, i.e. the HFNs associated with acknowledged mode data (AMD) PDUs of “Sequence Number”=VT(S)-1 if at least one AMD PDU had been transmitted or of “Sequence Number”=0 if no AMD PDU had been transmitted, are exchanged between the UE and UTRAN. The RESET PDUs and the RESET ACK PDUs have higher priority than AMD PDUs.

The RRC performs various functions. These functions include, broadcast of information related to the non-access stratum; broadcast of information related to the access stratum; establishment, maintenance and release of an RRC connection between the UE and UTRAN; establishment, reconfiguration and release of Radio Bearers; assignment, reconfiguration and release of radio resources for the RRC connection; RRC connection mobility functions; UE measurement reporting and control of the reporting; outer loop power control; control of ciphering; paging; initial cell selection and cell re-selection; arbitration of radio resources on uplink DCH; RRC message integrity protection; and timing advance (TDD mode). In order to perform these various functions RRC messages are utilized.

Currently the RRC uses three signaling radio bearers RB2, RB3 and RB4 using RLC AM mode to transmit RRC messages which require reliable transmission. Therefore the reset for AM RLC entities used by RB2, RB3 and RB4 may occur.

If an RLC reset occurs before receiving positive acknowledgements of all RLC PDUs transmitted, the PDUs not correctly received cannot be retransmitted after an RLC reset. The upper layer usually sets a timer for retransmission of an upper layer message contained in this RRC message. If before the timer expires no confirmation is delivered by the RRC or a response message is not received, the upper layer will retransmit this message after the timer expires. The value of the timer is set quite long in general. The RLC reset delays the transmission of messages of the upper layer. Because these messages of the upper layer through RB3 are used for signaling, the delay of such messages decreases the performance in wireless communications.

As shown in the scenario above, system performance is easily degraded with the conventional method.

In various situations and conditions, unspecified or improper actions during or after an RLC reset procedure may result in serious problems for the wireless communication system. These problems include wasted system resources, data loss, unnecessary retransmissions, and unsuccessful data decompression.

Therefore, there is need for an improved scheme for efficiently handling RRC messages during and after an RLC reset so that inappropriate actions are avoided, errors are reduced, system resources are not wasted, and wireless communication system performance is improved.

Therefore, the present invention provides a method for specifying actions for handling RRC messages during and after an RLC RESET which thereby improves wireless communication system performance and reduces wasting of system resources.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWING

The accompanying drawing is included to provide a further understanding of the invention, and is incorporated in and constitutes a part of this specification. The drawing illustrates embodiments of the invention and, together with the description, serves to explain the principles of the invention. In the drawing,

FIG. 1 is a diagram illustrating an elementary RLC reset procedure as defined by the 3rd Generation Partnership Project (3GPP) specification 3GPP TS 25.322 V3.11.0 “RLC protocol specification”, which is included herein by reference.

### DESCRIPTION OF THE PREFERRED EMBODIMENTS

Reference will now be made in detail to the preferred embodiments of the present invention, examples of which are illustrated in the accompanying drawing. Wherever possible, the same reference numbers are used in the drawing and the description to refer to the same or like parts.

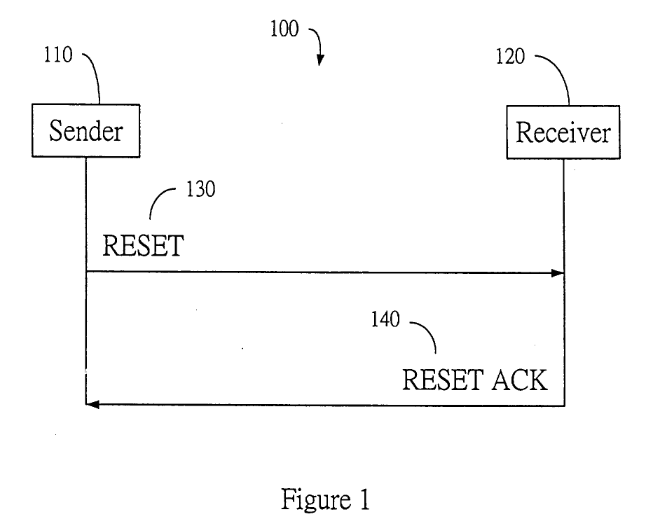

Refer to FIG. 1, which is a diagram illustrating an elementary RLC reset procedure 100. Basically, a sender 110 sends a reset 130 to a receiver 120. The receiver 120, should respond with a reset acknowledgement 140 to the sender 110.

An RLC reset procedure is used to reset two RLC peer entities, which are operating in acknowledged mode. During the reset procedure the hyper frame numbers (HFN) in the UTRAN and UE are synchronised. Two HFNs used for ciphering need to be synchronised, DL HFN in downlink and UL HFN in uplink. In the reset procedure, the highest UL HFN and DL HFN used by the RLC entity in the transmitting sides, i.e. the HFNs associated with AMD PDUs of “Sequence Number”=VT(S)-1 if at least one AMD PDU had been transmitted or of “Sequence Number”=0 if no AMD PDU had been transmitted, are exchanged between the UE and UTRAN. The RESET PDUs and the RESET ACK PDUs have higher priority than AMD PDUs.

Triggers that will result in an initiation procedure are, if “No_Discard after MaxDAT number of retransmissions” is configured and VT(DAT) equals the value MaxDAT; or if VT(MRW) equals the value MaxMRW; or if a STATUS PDU including “erroneous Sequence Number” is received.

If one of these triggers is detected, the sender will, stop transmitting any AMD PDU or STATUS PDU; submit a RESET PDU to the lower layer; and start the timer Timer_RST and increase VT(RST) with 1.

If the TFC selection exchange has been initiated by sending the RLC Entity Info parameter to the medium access control (MAC), the RLC entity may delay the RLC reset procedure until the end of the next transmission time interval (TTI).

When a reset procedure has been initiated it can only be ended upon reception of a RESET ACK PDU with the same RSN value as in the corresponding RESET PDU, or upon request of re-establishment or release from upper layer, a reset procedure is not interrupted by the reception of a RESET PDU from the peer entity.

When RESET PDU contents are to be set, the sender will set the HFNI field to the currently highest used HFN (DL HFN when the RESET PDU is sent by UTRAN or UL HFN when the RESET PDU is sent by the UE) and set the RSN field to the sequence number of the RESET PDU. The sequence number of the first RESET PDU after the AM entity is established or re-established shall be “0”. This sequence number is incremented every time a new RESET PDU is transmitted, but not when a RESET PDU is retransmitted.

Upon reception of a RESET PDU the receiver will perform the following. If the RSN value in the RESET PDU is the same as the RSN value in the last received RESET PDU, the receiver will either only submit a RESET ACK PDU to the lower layer with the contents set exactly as in the last transmitted RESET ACK PDU (i.e., in this case the RLC entity is not reset); or perform the actions specified below as if the RSN value was different from the RSN value in the last received RESET PDU.

Otherwise, if the RESET PDU is the first RESET PDU received since the entity was (re-)established or the RSN value is different from the RSN value in the last received RESET PDU, the receiver will submit a RESET ACK PDU to the lower layer with the content set; reset the state variables except VT(RST) to their initial values; stop all the timers except Timer_RST; reset configurable parameters to their configured values; discard all RLC PDUs in the receiving side of the AM RLC entity; discard all RLC SDUs that were transmitted before the reset in the transmitting side of the AM RLC entity; set the HFN (DL HFN when the RESET PDU is received in UE or UL HFN when the RESET PDU is received in UTRAN) equal to the HFNI field in the received RESET PDU; increase with one the UL HFN and DL HFN, and the updated HFN values shall be used for the first transmitted and received AMD PDUs after the reset procedure.

If the TFC selection exchange has been initiated by sending the RLC Entity Info parameter to MAC, the RLC entity may delay the RLC SDUs discard in the transmitting side of the AM RLC entity until the end of the next TTI.

The RESET ACK PDU contents to set are as follows. The receiver will set the hyper frame number indicator field (HFNI) to the currently highest used HFN (DL HFN when the RESET ACK PDU is sent by UTRAN or UL HFN when the RESET ACK PDU is sent by the UE) and set the RSN field to the same value as in the corresponding received RESET PDU.

Upon reception of a RESET ACK PDU, the sender will perform the following. If the sender has already transmitted a RESET PDU which has not been yet acknowledged by a RESET ACK PDU and if the received RSN value is the same as the one in the corresponding RESET PDU, the sender will set the HFN value (DL HFN when the RESET ACK PDU is received in UE or UL HFN when the RESET ACK PDU is received in UTRAN) to the HFNI field of the received RESET ACK PDU; reset the state variables to their initial values; stop all the timers; reset configurable parameters to their configured values; discard all RLC PDUs in the receiving side of the AM RLC entity; discard all RLC SDUs that were transmitted before the reset in the transmitting side of the AM RLC entity; and increase with one the UL HFN and DL HFN, and the updated HFN values shall be used for the first transmitted and received AMD PDUs after the reset procedure.

Otherwise, if the received RSN value is not the same as the one in the corresponding RESET PDU, the sender will discard the RESET ACK PDU.

If the sender has not transmitted a RESET PDU which has not been yet acknowledged by a RESET ACK PDU, the sender will discard the RESET ACK PDU.

If the TFC selection exchange has been initiated by sending the RLC Entity Info parameter to MAC, the RLC entity may delay the RLC SDUs discard in the transmitting side until the end of the next TTI.

The upper layers may re-establish an RLC entity. The RLC re-establishment function is applicable for acknowledged mode (AM) and unacknowledged mode (UM) and is used when upper layers request an RLC entity to be re-established.

When an RLC entity is re-established by upper layers, the RLC entity will reset the state variables to their initial value; set the configurable parameters to their configured value; and set the hyper frame number (HFN) in UL and DL to the value configured by upper layers.

If the RLC entity is operating in unacknowledged mode and if it is a receiving UM RLC entity, the RLC entity will discard all unacknowledged mode data (UMD) PDUs.

If the RLC entity is operating in unacknowledged mode and if it is a transmitting UM RLC entity, the RLC entity will discard the RLC SDUs for which one or more segments have been submitted to a lower layer.

Otherwise, if the RLC entity is operating in acknowledged mode, the RLC entity will discard all AMD PDUs and control PDUs in both the receiving side and the transmitting side of the RLC entity.

If the TFC selection exchange has been initiated by sending the RLC Entity Info parameter to MAC, the RLC entity may delay the re-establishment function until the end of the next TTI.

The RRC performs various functions. These functions include, broadcast of information related to the non-access stratum; broadcast of information related to the access stratum; establishment, maintenance and release of an RRC connection between the UE and UTRAN; establishment, reconfiguration and release of Radio Bearers; assignment, reconfiguration and release of radio resources for the RRC connection; RRC connection mobility functions; UE measurement reporting and control of the reporting; outer loop power control; control of ciphering; paging; initial cell selection and cell re-selection; arbitration of radio resources on uplink DCH; RRC message integrity protection; and timing advance (TDD mode).

In order to perform these various functions RRC messages are utilized. Radio Bearers (RB) available for transmission of RRC messages are defined as signaling radio bearers and are specified in the following. The UE and UTRAN shall select the signaling radio bearers for RRC messages using radio link control transparent mode (RLC TM), radio link control unacknowledged mode (RLC UM) or radio link control acknowledged mode (RLC AM) on the dedicated control channel (DCCH) and common control channel (CCCH), according to the following.

Signalling radio bearer RB1 is used for all messages sent on the CCCH (UL: RLC TM, DL: RLC UM).

Signalling radio bearer RB1 is used for all messages sent on the DCCH, when using RLC unacknowledged mode (RLC UM).

Signalling radio bearer RB2 is used for all messages sent on the DCCH, when using RLC acknowledged mode (RLC AM), except for the RRC messages carrying higher layer (NAS) signalling.

Signalling radio bearer RB3 and optionally Signalling radio bearer RB4 are used for the RRC messages carrying higher layer (NAS) signalling and sent on the DCCH in RLC acknowledged mode (RLC AM).

RRC messages on the shared channel control channel (SHCCH) are mapped either on random access channel (RACH) or on the uplink shared channel (USCH) in the uplink using TM and either on forward link access channel (FACH) or on the downlink shared channel (DSCH) using RLC-UM. These messages are only specified for time division duplex (TDD) mode.

When an RRC message is transmitted in DL on CCCH or SHCCH using RLC UM, the RRC should indicate to the RLC that a special RLC length indicator should be used. The UE shall assume that this indication has been given. The special length indicator indicates that an RLC SDU begins in the beginning of an RLC PDU.

Currently the RRC uses three signaling radio bearers RB2, RB3 and RB4 using RLC AM mode to transmit RRC messages which require reliable transmission. Therefore the reset for AM RLC entities used by RB2, RB3 and RB4 may occur.

However, in various situations and conditions, unspecified or improper actions during or after an RLC reset procedure may result in serious problems for the wireless communication system. These problems include wasted system resources, data loss, unnecessary retransmissions, and unsuccessful data decompression.

For greater understanding of the potential system problems, the following scenario is given for example.

Consider a message of the upper layer is submitted to the RRC through RB3. The RRC creates an RRC message containing this message and submits it to the RLC. The RLC segments it into several RLC PDUs and transmits these RLC PDUs. For this scenario assume that there are five RLC PDUs containing this RRC message.

The first two RLC PDUs are transmitted and positively acknowledged by the peer RLC. The last three RLC PDUs are transmitted. The reset occurs before receiving positive acknowledgements of the last three RLC PDUs. The last three PDUs may be received by the peer RLC or may not. If they are correctly received, the five RLC PDUs are assembled into an RLC SDU (i.e. RRC message) delivered to the peer RRC. If the last three RLC PDUs are not correctly received, they cannot be retransmitted after an RLC reset. The upper layer usually sets a timer for retransmission of upper layer message contained in this RRC message. If before the timer expires no confirmation is delivered by the RRC or a response message is not received, the upper layer will retransmit this message after the timer expires. The value of the timer is set quite long in general. The RLC reset delays the transmission of messages of the upper layer. Because these messages of the upper layer through RB3 are used for signaling, the delay of such messages decreases the performance in wireless communications.

As shown in the scenario above, system performance is easily degraded with the conventional method.

Therefore, there is need for an improved scheme for efficiently handling RRC messages during an RLC reset so that inappropriate actions are avoided, errors are reduced, system resources are not wasted, and wireless communication system performance is improved.

Therefore, the present invention provides a method for specifying actions for handling RRC messages during an RLC RESET which thereby improves wireless communication system performance and reduces wasting of system resources.

In an embodiment of the present invention, when an RLC reset occurs, the RLC indicates to the RRC. Because the RRC is informed of the RLC reset, the RRC can retransmit those messages which were submitted to the RLC before the RLC reset and might not be received correctly by the peer RRC due to the RLC reset. This method prevents the problem described in the scenario above.

Referring back to the scenario above, the first two RLC PDUs were transmitted and positively acknowledged by the peer RLC. The last three RLC PDUs were transmitted. The reset occurred before receiving positive acknowledgements of the last three RLC PDUs. The last three PDUs may or may not have been received by the peer RLC.

Utilizing an embodiment of the present invention, because the RRC is informed of the RLC reset, the RRC can retransmit those messages which were submitted to the RLC before the RLC reset and might not be received correctly by the peer RRC due to the RLC reset.

In this way, delays associated with the conventional method are avoided and system performance in wireless communications is improved.

As shown above, there is need for an improved scheme for efficiently handling RRC messages during an RLC reset so that inappropriate actions are avoided, errors are reduced, system resources are not wasted, and wireless communication system performance is improved.

Therefore, the present invention provides a method for specifying actions for handling RRC messages during an RLC RESET which thereby improves wireless communication system performance and reduces wasting of system resources.

Note that the embodiments of the present invention described above are only examples. In other embodiments, various other steps or methods are utilized for handling resets or RRC messages without deviating from the scope of the present invention of specifying actions taken so that inappropriate actions are avoided and wireless communication system performance is improved.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method for improving wireless communication system performance comprising:
detecting a radio link control (RLC) reset event by an RLC entity; and
notifying radio resource control (RRC) by the RLC entity indicating that an RLC reset occurred;
whereby since the RRC is informed of the RLC reset, the RRC can retransmit those messages which were submitted to the RLC before the RLC reset.

2. The method for improving wireless communication system performance of claim 1, wherein detecting a radio link (RLC) reset event by an RLC entity is receiving a RESET Protocol Data Unit (PDU) by an RLC entity.

3. The method for improving wireless communication system performance of claim 1, wherein detecting a radio link (RLC) reset event by an RLC entity is receiving a RESET acknowledgement (ACK) Protocol Data Unit (PDU) by an RLC entity.

4. The method for improving wireless communication system performance of claim 1, wherein detecting a radio link (RLC) reset event by an RLC entity is detecting a condition for sending a RLC RESET Protocol Data Unit (PDU) by an RLC entity.

5. A method for improving wireless communication system performance comprising:
detecting a radio link control (RLC) reset event by an RLC entity;
notifying radio resource control (RRC) by the RLC entity indicating that an RLC reset occurred; and
retransmitting messages by the RRC to the RLC which were submitted to the RLC before the RLC reset.

6. The method for improving wireless communication system performance of claim 5, wherein detecting a radio link (RLC) reset event by an RLC entity is receiving a RESET Protocol Data Unit (PDU) by an RLC entity.

7. The method for improving wireless communication system performance of claim 5, wherein detecting a radio link (RLC) reset event by an RLC entity is receiving a RESET acknowledgement (ACK) Protocol Data Unit (PDU) by an RLC entity.

8. The method for improving wireless communication system performance of claim 5, wherein detecting a radio link (RLC) reset event by an RLC entity is detecting a condition for sending a RLC RESET Protocol Data Unit (PDU) by an RLC entity.

9. A method for improving wireless communication system performance comprising:
transmitting radio link control (RLC) protocol data units (PDUs) by an RLC sender;
receiving the RLC PDUs by an RLC receiver;
whereby if the RLC PDUs are correctly received by the RLC receiver, the RLC receiver transmits an acknowledgement to the RLC sender;
receiving a radio link control (RLC) reset by an RLC entity;
notifying radio resource control (RRC) by the RLC entity indicating that an RLC reset was received; and
retransmitting those messages by the RRC to the RLC which were submitted to the RLC receiver before the RLC reset and were not acknowledged by the RLC receiver.
